(19) United States
(12) Patent Application Publication
(10) Pub. No.: US 2024/0378060 A1
(43) Pub. Date: Nov. 14, 2024

(54) INSPECTION METHOD AND RELATED INSPECTION DEVICE FOR OUT-OF-ORDER EXECUTION CENTRAL PROCESSING UNIT CIRCUIT

(71) Applicant: Realtek Semiconductor Corp., HsinChu (TW)

(72) Inventors: Yean-Ru Chen, Tainan City (TW); Chien-Hsiang Lin, Yilan County (TW); En-Hsiang Lin, HsinChu (TW)

(73) Assignee: Realtek Semiconductor Corp., HsinChu (TW)

(21) Appl. No.: 18/527,383

(22) Filed: Dec. 4, 2023

(30) Foreign Application Priority Data
May 11, 2023 (TW) 112117495

(51) Int. Cl. G06F 9/38

(52) U.S. Cl. CPC G06F 9/3856; G06F 9/3861

(57) ABSTRACT

An inspection method for an out-of-order execution processing circuit, includes determining that a refill request is not sent by a data cache unit of the out-of-order execution processing circuit before an exception commitment triggered by a permission check failure of the out-of-order execution processing circuit; and determining a key data is not read by a load-store unit of the out-of-order execution processing circuit and the key data is not utilized by a calculation unit of the out-of-order execution processing circuit before the exception commitment triggered by the permission check failure of the out-of-order execution processing circuit.

### BACKGROUND OF THE INVENTION

### 1. Field of the Invention

The present invention relates to an inspection method for an out-of-order execution processing circuit and related inspection device, to an inspection method for an out-of-order execution processing circuit and related inspection device capable of thoroughly inspecting the out-of-order processing circuit with formal methods.

### 2. Description of the Prior Art

Meltdown is the hardware vulnerability of out-of-order executions and permission check of conventional processors, and the meltdown attack leaks key data with side channel.

As shown in FIG. 1, which is a schematic diagram of the conventional meltdown attack method. Array [idx] in FIG. 1 is the memory address of a kernel space, which cannot be read by a user space. That is, contents of array [idx] are the key data that cannot be read. The processor reads the data of the address of array [idx] and performs permission check during the user process. Since the user space cannot obtain the data of the kernel space, the above permission check will fail and trigger an exception commitment.

However, the timing of the exception commitment triggered by the permission check failure is later than the timing of reading data. In this situation, the meltdown attack may read the key data, i.e. array [idx], via a probe array, and the address information may be obtained due to the time difference. Kernel page-table isolation method is a conventional software based solution to the issue; however, the Kernel page-table isolation method affects the system efficiency. Therefore, an improvement to the conventional technique is necessary.

### SUMMARY OF THE INVENTION

In light of this, the present invention provides an inspection method for an out-of-order execution processing circuit and related inspection device, which determines that circuits of the processor supporting the out-of-order execution may effectively prevent the meltdown attacks.

An embodiment of the present invention discloses an inspection method for an out-of-order execution processing circuit, comprises determining that a refill request is not sent by a data cache unit of the out-of-order execution processing circuit before an exception commitment triggered by a permission check failure of the out-of-order execution processing circuit; and determining a key data is not read by a load-store unit of the out-of-order execution processing circuit and the key data is not utilized by a calculation unit of the out-of-order execution processing circuit before the exception commitment triggered by the permission check failure of the out-of-order execution processing circuit.

Another embodiment of the present invention discloses an inspection device for an out-of-order execution processing circuit, comprises a finite state graph module, configured to transform a to-be inspected circuit into at least a finite state graph; a logic expression transformation module, configured to transform at least a validation property into at least a logic expression; and a module validating circuit, configured to perform a model validation process for the at least a finite state graph and the at least a logic expression to determine whether the to-be inspected circuit conforms to the at least a validation property or not; wherein the validation property includes an inspection method of the out-of-order execution processing circuit, and the inspection method of the out-of-order execution processing circuit comprises determining that a refill request is not sent by a data cache unit of the out-of-order execution processing circuit before an exception commitment triggered by a permission check failure of the out-of-order execution processing circuit; and determining a key data is not read by a load-store unit of the out-of-order execution processing circuit and the key data is not utilized by a calculation unit of the out-of-order execution processing circuit before the exception commitment triggered by the permission check failure of the out-of-order execution processing circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional meltdown attack method.

FIG. 2 is a schematic diagram of a structure of a conventional processor supporting out-of-order executions.

FIG. 3 and FIG. 4 are schematic diagrams of a validation property according to an embodiment of the present invention.

FIG. 5 is a schematic diagram of a formal validating inspection device according to an embodiment of the present invention.

FIG. 6 is a schematic diagram of a validation process according to an embodiment of the present invention.

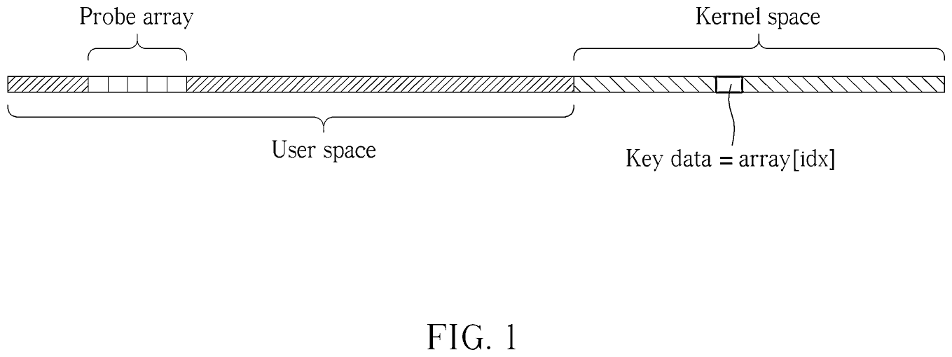

### DETAILED DESCRIPTION

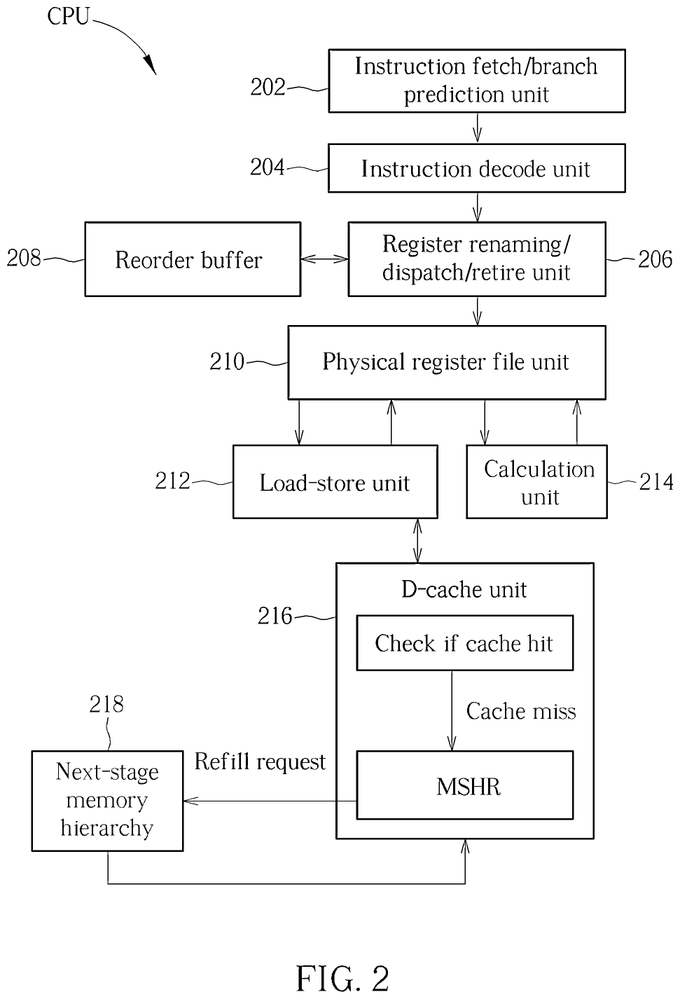

Please refer to FIG. 2, which is a schematic diagram of a structure of a conventional processor CPU supporting out-of-order executions. The processor CPU includes an instruction fetch/branch prediction unit 202, an instruction decode unit 204, a register renaming/dispatch/retire unit 206, a reorder buffer 208, a physical register file unit 210, a load-store unit 212, a calculation unit 214, a D-cache unit 216 and a next-stage memory hierarchy 218. In an embodiment, the register renaming/dispatch/retire unit 206 may include different implemented details, e.g. I-cache.

The data cache unit 216 of the processor CPU inspects whether a cache hit happens or not, if an inspection result is “yes”, i.e. the cache hit happens, the cache hit is sent back to the load-store unit 212; if a cache miss happens, a miss status holding/handling register (MSHR) of the data cache unit 216 is utilized for recording the cache miss, and sending a refill request to the next-stage memory hierarchy 218. In an example, the next-stage memory hierarchy 218 may be a level-2 cache memory or a memory bus.

Since a timing of exception commitment after a permission check is later than a timing of reading data when the conventional processor performs the out-of-order executions, such that key data may be read by the conventional meltdown attack due to the timing difference.

In order to determine whether the key data of the load-store unit 212 is utilized by the calculation unit 214 or not, before the exception commitment t triggered by the permission check, the following validation properties are verified by the processor CPU according to an embodiment of the present invention:
1. The load-store unit 212 writes the key data to the physical register file unit 210;
2. The key data is utilized by the calculation unit 214;
3. The reorder buffer 208 determines whether 1 and 2 happen before the exception commitment triggered by the permission check or not.

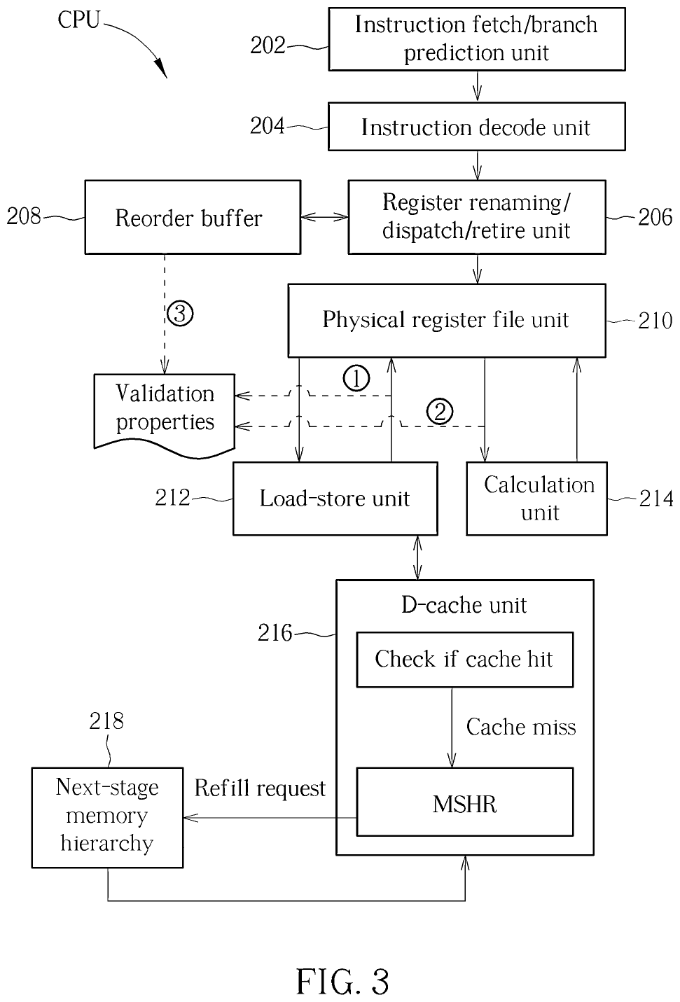

Please refer to FIG. 3, which is a schematic diagram of a validation property according to an embodiment of the present invention. As can be known from FIG. 3, by determining whether the load-store unit 212 writes the key data to the physical register file unit 210 or not, determining whether the key data is utilized by the calculation unit 214 or not, and determining whether the key data, which is identified by the reorder buffer 208 for detecting of the inspection period, is utilized by the calculation unit 214 or not, whether the validation properties 1, 2 are before the exception commitment triggered by the permission check is determined or not. In addition, the validation properties of the processor CPU are inspected as tenability by determining whether the key data of the load-store unit 212 is utilized by the calculation unit 214 or not, before the exception commitment triggered by the permission check.

Notably, in the example of FIG. 3, the sequence of validation properties 1, 2, 3 is not fixed, when any one of the validation properties 1, 2, 3 is satisfied, the key data of the load-store unit 212 is utilized by the calculation unit 214.

On the other hand, in order to determine that the refill request corresponding to the key data is not sent by the data cache unit 216 to determine that the processor CPU is in the status of before the exception commitment triggered by the permission check, validation properties of the following events are established by the processor CPU according to an embodiment of the present invention:
1. Cache miss;
2. When cache miss happens, determine whether the request refill is sent to the next-stage memory hierarchy 218 or not;
3. Determine, by the reorder buffer 208, whether 1 and 2 are before the exception commitment triggered by the permission check or not.

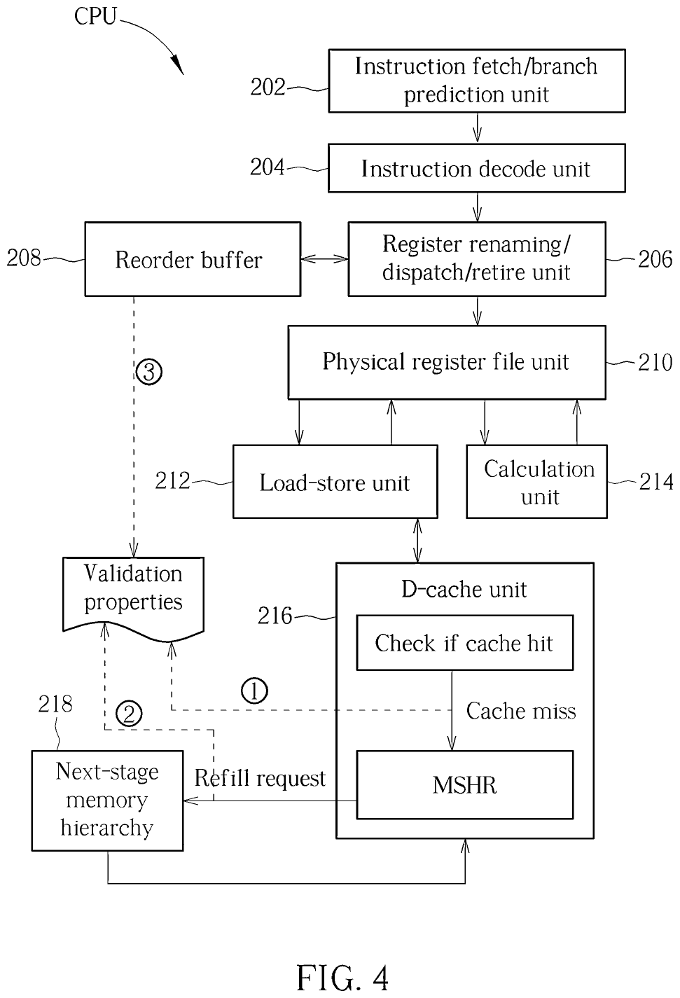

Please refer to FIG. 4, which is a schematic diagram of a validation property according to another embodiment of the present invention. As can be known from FIG. 4, by determining no cache miss in the data cache unit 216, determining whether the data cache unit 216 sends a refill request to the next-stage memory hierarchy 218 or not, and identifying, by the reorder buffer 208, the inspection period for the detection of cache miss to determine whether 1 and 2 are before the exception commitment triggered by the permission check or not. In addition, the validation properties of the processor CPU are inspected as tenability by determining that the key data is not sent by the data cache unit 216 for the refill request before the exception commitment triggered by the permission check of the processor CPU.

Notably, in the example of FIG. 4, the sequence of validation properties 1, 2, 3 is not fixed, when any one of the validation properties 1-3 is satisfied, the data cache unit 216 sends the key data to request refill.

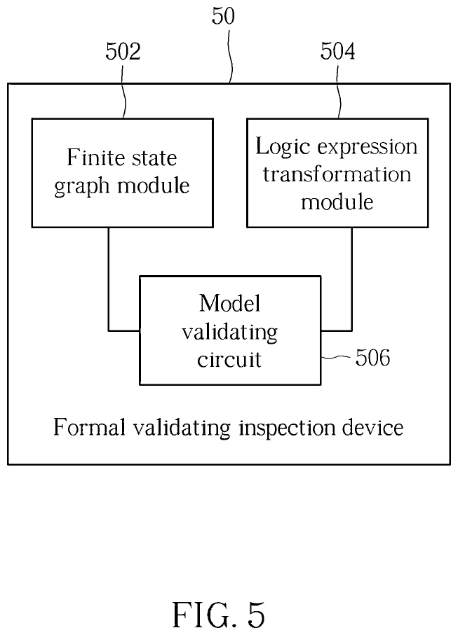

Please refer to FIG. 5, which is a schematic diagram of a formal validating inspection device 50 according to an embodiment of the present invention. The formal validating inspection device 50 includes a finite state graph module 502, a logic expression transformation module 504 and a model validating circuit 506. The formal validating inspection device 50 adopts the formal method of mathematical corollary proof. The finite state graph module 502 is configured to transform a to-be inspected circuit into at least a finite state graph and logic gate. The logic expression transformation module 504 is configured to transform at least a validation property into at least a logic expression, e.g. transform the validation properties in FIG. 3 and FIG. 4 into corresponding assertions. The module validating circuit 506 is configured to determine the tenability of the finite state graph and the at least a logic expression, wherein the module validating circuit 506 may be a formal model validator of Electronic Design Automation (EDA), which compares the to-be inspected circuit with the logic expression of the assertion and determines the equality of the two models with mathematical proof, if the equality holds, the to-be inspected circuit conforms to the validation properties; if not, the to-be inspected circuit does not conform to the validation properties.

In this way, when the module validating circuit 506 determines that the tenability of the validation properties holds on the to-be inspected circuit, the validation is passed and the process is ended; in contrast, when a counterexample is found by the module validating circuit 506, a user may amend the to-be inspected circuit according to the counterexample.

Therefore, when the processor supporting the out-of-order executions, i.e. the to-be inspected circuit, cannot pass the corresponding validation properties in FIG. 3 and FIG. 4, the processor cannot prevent the meltdown attacks.

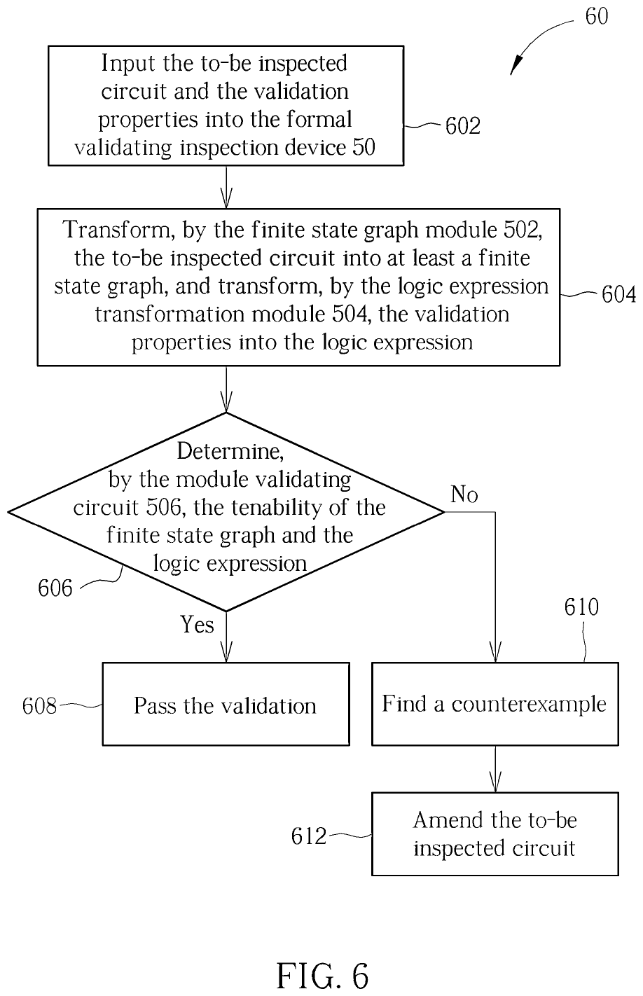

Please refer to FIG. 6, which is a schematic diagram of a validation process 60 according to an embodiment of the present invention. The validation process 60 can be summarized according to an operation method of the formal validating inspection device 50. The validation process 60 includes the following steps:
Step 602: Input the to-be inspected circuit and the validation properties into the formal validating inspection device 50;
Step 604: Transform, by the finite state graph module 502, the to-be inspected circuit into at least a finite state graph, and transform, by the logic expression transformation module 504, the validation properties into the logic expression;
Step 606: Determine, by the module validating circuit 506, the tenability of the finite state graph and the logic expression, if the tenability holds, goes to step 608; if not, goes to step 610;
Step 608: Pass the validation;
Step 610: Find a counterexample;
Step 612: Amend the to-be inspected circuit.

For those skilled in the art, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry.

Notably, the structure of the processor and the logic expression corresponding to the verification properties can be modified according to different user's preferences or system settings, which are all within the scope of the present invention.

In summary, the present invention provides an inspection method for an out-of-order execution processing circuit and related inspection device, which validates related circuits with formal method to determine that circuits of the processor supporting the out-of-order execution may effectively prevent the meltdown attacks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inspection method for an out-of-order execution processing circuit, comprising:
determining that a refill request is not sent by a data cache unit of the out-of-order execution processing circuit before an exception commitment triggered by a permission check failure of the out-of-order execution processing circuit; and
determining a key data is not read by a load-store unit of the out-of-order execution processing circuit and the key data is not utilized by a calculation unit of the out-of-order execution processing circuit before the exception commitment triggered by the permission check failure of the out-of-order execution processing circuit.

2. The inspection method of claim 1, wherein the step of determining the key data is not read by the load-store unit of the out-of-order execution processing circuit and the key data is not utilized by the calculation unit of the out-of-order execution processing circuit before the exception commitment triggered by the permission check failure of the out-of-order execution processing circuit comprises:
determining whether the key data is written on a physical register file by the load-store unit of the out-of-order execution processing circuit or not.

3. The inspection method of claim 1, wherein the step of determining the key data is not read by the load-store unit of the out-of-order execution processing circuit and the key data is not utilized by the calculation unit of the out-of-order execution processing circuit before the exception commitment triggered by the permission check failure of the out-of-order execution processing circuit comprises:
determining whether the key data is utilized by the calculation unit of the out-of-order execution processing circuit or not.

4. The inspection method of claim 1, wherein the step of determining the key data is not read by the load-store unit of the out-of-order execution processing circuit and the key data is not utilized by the calculation unit of the out-of-order execution processing circuit before the exception commitment triggered by the permission check failure of the out-of-order execution processing circuit comprises:
determining that no permission check failure exists before the exception commitment triggered by a reorder buffer of the out-of-order execution processing circuit submitting the key data.

5. The inspection method of claim 1, wherein the step of determining that the refill request is not sent by the data cache unit of the out-of-order execution processing circuit before the exception commitment triggered by the permission check failure of the out-of-order execution processing circuit comprises:
determining no cache miss in the data cache unit of the out-of-order execution processing circuit.

6. The inspection method of claim 1, wherein the step of determining that the refill request is not sent by the data cache unit of the out-of-order execution processing circuit before the exception commitment triggered by the permission check failure of the out-of-order execution processing circuit comprises:
determining whether the data cache unit of the out-of-order execution processing circuit sends a refill request to a next-stage memory hierarchy of the out-of-order execution processing circuit or not.

7. The inspection method of claim 1, wherein the step of determining that the refill request is not sent by the data cache unit of the out-of-order execution processing circuit before the exception commitment triggered by the permission check failure of the out-of-order execution processing circuit comprises:
determining that no the permission check failure exists before the exception commitment triggered by a reorder buffer of the out-of-order execution processing circuit submitting the key data.

8. An inspection device for an out-of-order execution processing circuit, comprising:
a finite state graph module, configured to transform a to-be inspected circuit into at least a finite state graph;
a logic expression transformation module, configured to transform at least a validation property into at least a logic expression; and
a module validating circuit, configured to perform a model validation process for the at least a finite state graph and the at least a logic expression to determine whether the to-be inspected circuit conforms to the at least a validation property or not;
wherein the validation property includes an inspection method of the out-of-order execution processing circuit, and the inspection method of the out-of-order execution processing circuit comprises:
determining that a refill request is not sent by a data cache unit of the out-of-order execution processing circuit before an exception commitment triggered by a permission check failure of the out-of-order execution processing circuit; and
determining a key data is not read by a load-store unit of the out-of-order execution processing circuit and the key data is not utilized by a calculation unit of the out-of-order execution processing circuit before the exception commitment triggered by the permission check failure of the out-of-order execution processing circuit.

9. The inspection device of claim 8, wherein the step of determining the key data is not read by the load-store unit of the out-of-order execution processing circuit and the key data is not utilized by the calculation unit of the out-of-order execution processing circuit before the exception commitment triggered by the permission check failure of the out-of-order execution processing circuit comprises:
determining whether the key data is written on a physical register file or not by the load-store unit of the out-of-order execution processing circuit.

10. The inspection device of claim 8, wherein the step of determining the key data is not read by the load-store unit of the out-of-order execution processing circuit and the key data is not utilized by the calculation unit of the out-of-order execution processing circuit before the exception commitment triggered by the permission check failure of the out-of-order execution processing circuit comprises:
determining whether the key data is utilized by the calculation unit of the out-of-order execution processing circuit or not.

11. The inspection device of claim 8, wherein the step of determining the key data is not read by the load-store unit of the out-of-order execution processing circuit and the key data is not utilized by the calculation unit of the out-of-order execution processing circuit before the exception commitment triggered by the permission check failure of the out-of-order execution processing circuit comprises:
determining that no the permission check failure exists before the exception commitment triggered by a reorder buffer of the out-of-order execution processing circuit submitting the key data.

12. The inspection device of claim 8, wherein the step of determining that the refill request is not sent by the data cache unit of the out-of-order execution processing circuit before the exception commitment triggered by the permission check failure of the out-of-order execution processing circuit comprises:
determining no cache miss in the data cache unit of the out-of-order execution processing circuit.

13. The inspection device of claim 8, wherein the step of determining that the refill request is not sent by the data cache unit of the out-of-order execution processing circuit before the exception commitment triggered by the permission check failure of the out-of-order execution processing circuit comprises:
determining whether the data cache unit of the out-of-order execution processing circuit sends a refill request to a next-stage memory hierarchy of the out-of-order execution processing circuit or not.

14. The inspection device of claim 8, wherein the step of determining that the refill request is not sent by the data cache unit of the out-of-order execution processing circuit before the exception commitment triggered by the permission check failure of the out-of-order execution processing circuit comprises:
determining that no the permission check failure exists before the exception commitment triggered by a reorder buffer of the out-of-order execution processing circuit submitting the key data.
